(19) United States
(12) Patent Application Publication
(10) Pub. No.: US 2002/0148371 A1
(43) Pub. Date: Oct. 17, 2002

(54) Method for manufacturing a printing forme, as well as printing method using a printing forme thus manufactured

(76) Inventors: Norbertus Franciscus Jacobus Elemans, Westerbeek (NL); Thomas Maria Jonkers, Ts Boxmeer (NL); Karst Jan Van Weperen, Nk Uden (NL)

Correspondence Address: OSTROLENK FABER GERB & SOFFEN, 1180 AVENUE OF THE AMERICAS, NEW YORK, NY, 100368403

(21) Appl. No.: 10/015,178

(22) Filed: Nov. 16, 2001

Related U.S. Application Data
(63) Continuation of application No. PCT/NL00/00341, filed on May 19, 2000.

(30) Foreign Application Priority Data
May 19, 1999 (NL) 1012099

(51) Int. Cl. B41L 13/00; B05C 17/06

(52) U.S. Cl. 101/128.4; 101/127

(57) ABSTRACT

A method for producing a printing forme with printing openings which define an image which is to be printed comprises the steps of determining the contours of the image which is to be printed, positioning contour printing openings in accordance with the determined contours on the contour lines or at a predetermined, fixed distance therefrom, in a preform of the printing forme. If desired, additional printing openings may be provided within the area which is delimited by the contour printing openings. When a printing forme which has been produced in this way is used, a very sharply defined image is printed.

### CROSS-REFERENCE TO RELATED APPLICATION

This is a continuation application of PCT/NL 00/00341 filed May 19, 2000, which PCT application claims priority of Dutch patent application 1012099 filed May 19, 1999, herein incorporated by reference.

### FIELD OF THE INVENTION

The invention relates to a method for manufacturing a printing forme with printing openings which define an image which is to be printed.

### BACKGROUND OF THE INVENTION

A method of this type is generally known. In a known method, a design of the image to be printed is scanned and converted into an arrangement of printing openings which are to be formed. A preform of a printing forme, i.e. a cylindrical or flat screen, which has a desired fineness (mesh) and in which the screen openings are arranged in a fixed grid, is provided with a layer of photoresist or resin, which is then exposed and developed using light, in accordance with the arrangement of printing openings which has been defined in this way, and the exposed or unexposed parts of the photoresist layer are removed, depending on whether a positive or negative photoresist has been used, which after stoving of the resist remaining on the preform results in a stencil, i.e. printing forme with printing pattern, which is ready for use in a screen-printing method.

In another known method, there is no light-sensitive photoresist used as a covering layer, but rather the printing pattern is made in a suitable layer of resin or plastic by means of engraving (down to the preform). This engraving can be carried out using a laser, such as a CO₂ laser.

In yet another known method, a printing forme is produced by the electrodeposition (electroforming) of metals on a mould with a pattern of the printing openings which are to be formed. In this known method, therefore, the printing forme with printing openings, which therefore does not include a covering layer, is formed in one step. A printing forme produced in this way is known in the trade as a “galvano”.

In yet another known technique, the printing pattern, comprising the printing openings arranged in a fixed grid, are made directly in a thin-walled preform, which may be either a plate or a cylinder, by perforation. A printing forme obtained in this way, which, like the electroformed printing forme, does not include a covering layer, is also referred to in this description as a “galvano”, despite the fact that there is no electrodeposition of metals in this technique. A laser can be used to make the perforations which define the image which is to be printed, as described for the production of a plastic stencil in, for example, Dutch patent application NL-A-8802144.

One of the drawbacks when positioning the printing openings in a fixed grid is that it is not the whole of the contours of the image to be printed which is provided with printing openings, but rather only certain parts thereof. For example, in the first printing forme referred to above, the printing openings ultimately obtained do not entirely correspond to the screen openings. When a printing forme with such a pattern of printing openings of this nature is used for printing, therefore, sharp edges are not obtained on the printed image, owing to the grid used for positioning the printing openings and owing to the printing paste or ink spreading. Although it is possible to increase the printing quality by using screens with a high mesh number, screens of this type also have drawbacks, including the difficulty of fabrication, the poor handleability, the high susceptibility to creasing and blockages, and an increased resistance to the flow of printing ink or paste.

### SUMMARY OF THE INVENTION

The object of the present invention is to provide a method for producing a printing forme which has printing openings defining an image which is to be printed and which can be used to print sharply defined images. Another object of the invention is to provide a method for producing a printing forme of this type in which the abovementioned drawbacks of a screen with a high mesh number are eliminated.

To this end, the method according to the invention of the type described above comprises the steps of determining the contours of the image to be printed and positioning contour printing openings in accordance with the determined contours, on the contour lines or at a predetermined, fixed distance therefrom, in a preform of the printing forme.

It should be noted that in the present description printed image is understood to mean an image in one colour. Consequently, a multicoloured image is built up from a plurality of printed images.

Furthermore, it should be noted that U.S. Pat. No. 5,341,157 has disclosed a method for producing screen printing formes in which an image which is to be printed, for example K, is translated into a so-called bitmap and printing openings which define the image to be printed are burned into a non-porous plate with the aid of a suitable laser system. According to the drawing of this patent, some printing openings are positioned at a fixed distance from a peripheral part of the printed image, apparently as a result of the step size of the XY table employed and the coincidence of such a peripheral part running parallel to one of the axes of the XY table. However, it is clear that the printing openings which are positioned closest to the contours do not follow these contours throughout, i.e. the printing openings are not made on or at a predetermined, fixed distance from the contour lines, which is the case in the invention.

In the method according to the invention, which relates to the production of a “galvano” as described above, contour printing openings, which define the contours of an image to be printed, are not positioned in a fixed grid, but rather in accordance with the contours themselves which are determined prior to this step. Working on the basis of a given density of printing openings per unit surface area, printing with a printing forme manufactured according to the invention results in a printed image with sharper edges than those obtained when printing using a printing forme which, in accordance with the prior art, is provided with printing openings using a fixed grid. In other words, in the method according to the invention the positioning options for the contour printing openings are determined by the contours of the image rather than, as in the prior art, by the image and the grid, so that according to the invention there is a wider choice available for where to position the contour printing openings. Additional printing openings, if the image, the opening dimensions selected and the number of openings permit, are provided inside the area delimited by the contour printing openings. These additional printing openings may, for example, be positioned in accordance with a fixed grid, as is known from the prior art (cf., for example, GB-A-2,050,104), and in accordance with a so-called “scatter” grid, in which the printing openings are positioned arbitrarily, or in accordance with a pattern of openings, which pattern also follows the previously determined contours (and therefore also the contour printing openings). If the printed image is a very thin line, such as for example dividing lines between adjoining solid-print areas, it is possible for contour printing openings alone to be provided.

### BRIEF DESCRIPTION OF THE DRAWING

The invention is explained in more detail below with reference to the appended drawing, in which:

FIG. 1 is the original of a multicolour printed image which is to be printed;

FIGS. 2-5 show four separations for each colour of the original shown in FIG. 1;

FIGS. 6-9 show exposed, developed printing formes for each of the separations shown in FIGS. 2-5, as produced according to the prior art; and

FIGS. 10-13 show printing formes for each of the separations shown in FIGS. 2-5 which have been produced using the method according to the invention.

### DESCRIPTION OF THE PREFERRED EMBODIMENTS

In the method according to the invention, the contour printing openings are positioned on or at a predetermined, fixed distance from (i.e. parallel to) contour lines of the image. The latter option is preferably used, since it is necessary to take into account some spreading of the printing paste in the substrate, for example textile. The distance to the contour lines is selected as a function of factors such as the type of printing paste in conjunction with spreading and the width of the line or border of the image which is to be printed. These factors also determine the size of the contour printing openings and the number of such openings. The dimensions and shape of the contour printing openings can be varied; by way of example, to print an image which tapers to a point, the wide part of this image can be provided with large-diameter printing openings, while as the width of the image decreases the dimensions of the printing openings also decrease.

The contour printing openings are arranged on or at a fixed distance from the determined contour lines and advantageously at a fixed distance from one another using a suitable algorithm. An algorithm of this type is known per se, for example from software for processing photographs, such as that which can be obtained from Adobe.

When the positions of the contour printing openings and, if desired, additional printing openings have been determined in this way and, for example, stored in a computer memory, the contour printing openings and additional printing openings can themselves be made at these positions, for example using high-energy radiation, for example radiation from a laser which is arranged movably with respect to the preform, in a thin-walled preform. A preform of this type is preferably made from plastic which can be perforated using, for example, a CO₂ laser or a YAG laser. Preforms which are made from metal such as nickel or stainless steel can be processed using an excimer laser. An electron beam (E-beam) may also be considered. If desired, the printing openings can be widened on the substrate side by means of engraving using the laser. With printing openings of this type, the spreading takes place in a defined way in the printing forme itself, rather than in the substrate, so that the printing quality can be increased further, as described, for example in WO 97/48020 for a stencil.

If it is desired to use a metal printing forme, for example made from nickel, for the printing, the printing forme with contour printing openings may advantageously be formed by means of electroforming, which is a generally known technique for the production of screens and requires no further explanation here.

The invention also relates to a method for printing substrates with a printed image, in which a printing forme which has been produced in accordance with the method according to the invention as described above is used.

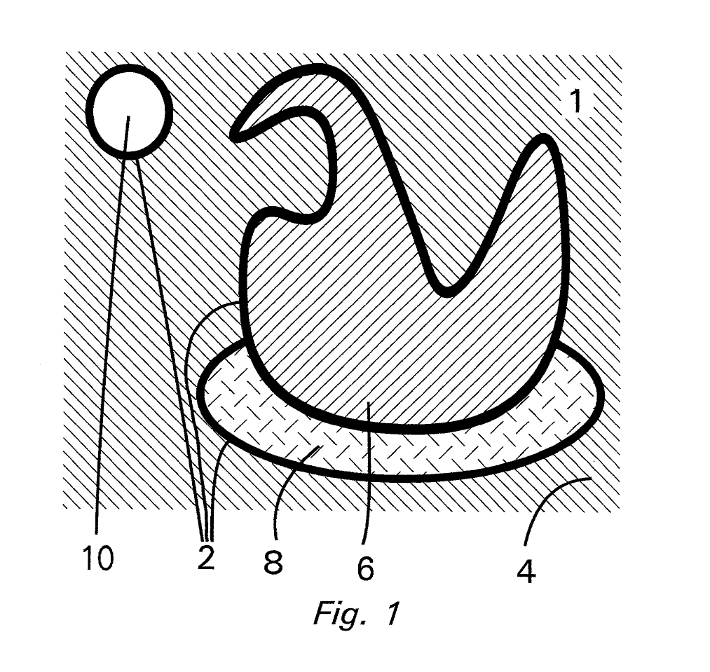

In the drawing, FIG. 1 shows an original of an image which is to be printed, denoted overall by reference numeral 1. In the example illustrated, this image comprises dividing lines 2 which are to be printed in black, a background 4 which is to be printed in green, a bird shape 6 which is to be printed in pink and a pond 8 which is to be printed in blue. The circle 10 is not printed (in other words in the end product, the printed (textile) substrate, the circle will be in the colour of the substrate).

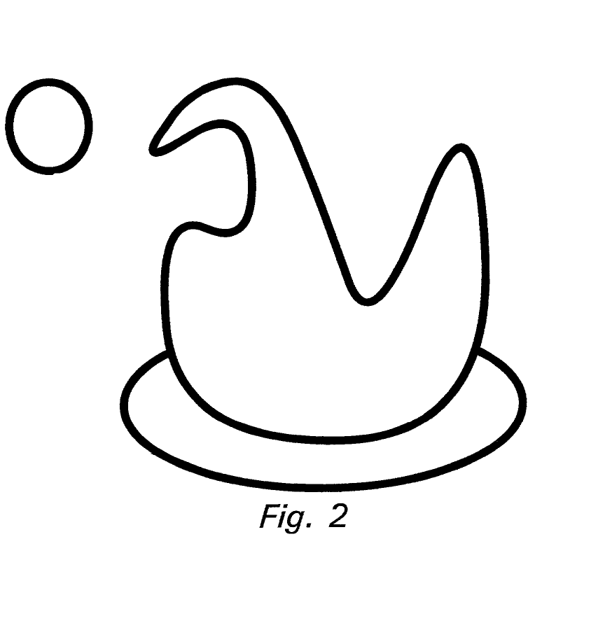

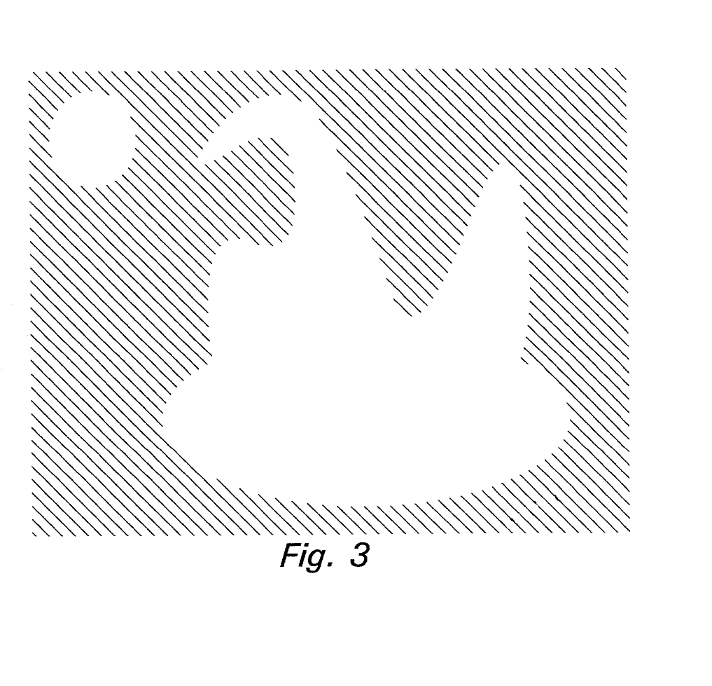

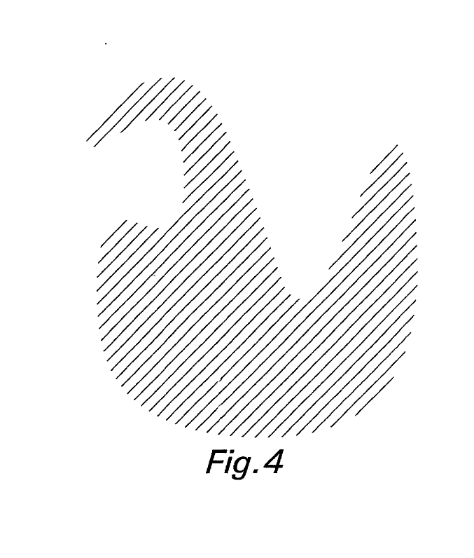

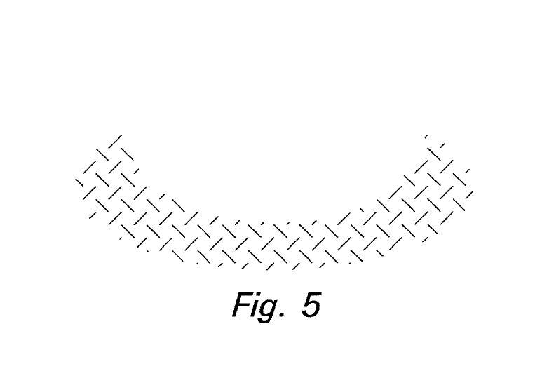

This image 1 is separated into the colours which are to be printed separately, in this case black (FIG. 2), green (FIG. 3), pink (FIG. 4) and blue (FIG. 5). This separation takes place in accordance with the prior art and is independent of the printing formes to be used or the grid of printing openings in the corresponding printing formes. These separations determine the contour lines of each printed image for each colour. In the figures to be discussed below, these contour lines are indicated by dashed lines 12, 14, 16 and 18, respectively.

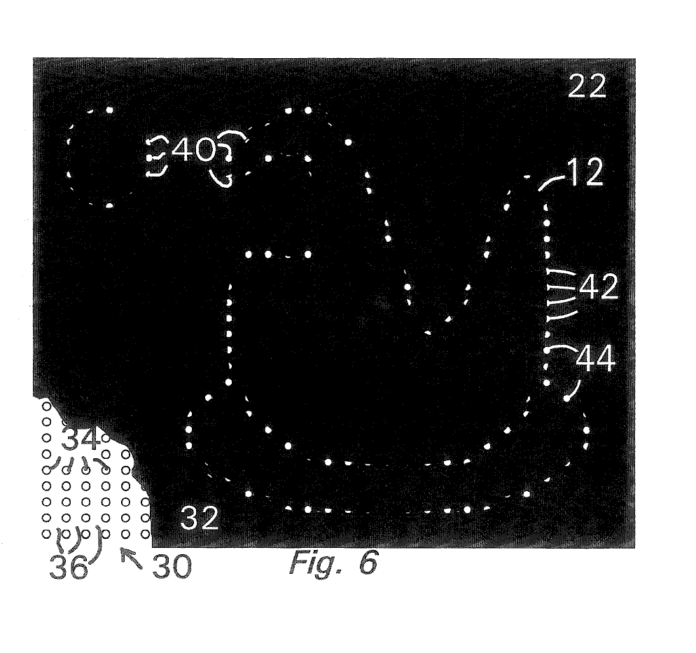

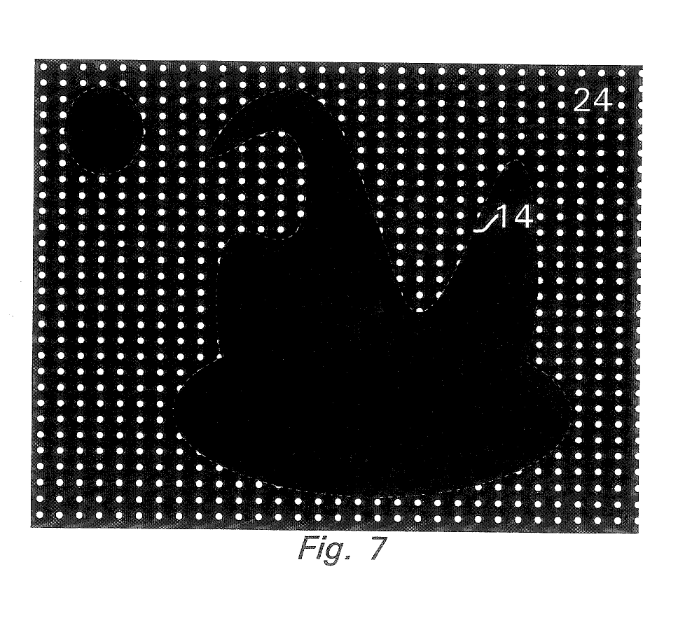

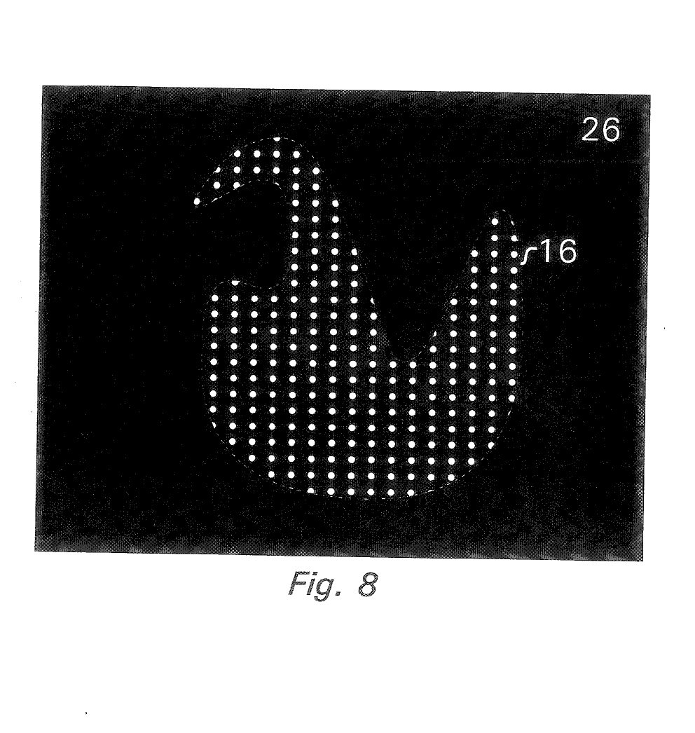

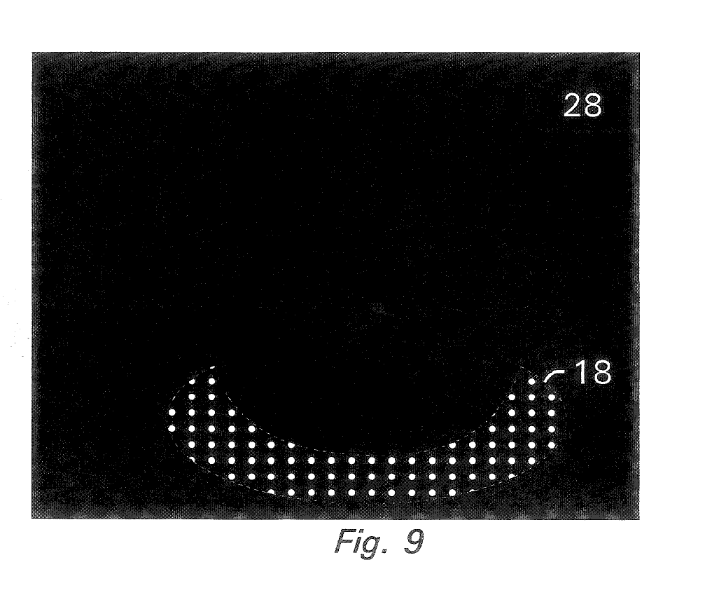

FIGS. 6-9 show printing formes 22, 24, 26 and 28 for each of the colours to be printed in accordance with the colour separations shown in FIGS. 2-5. These printing formes 22, 24, 26 and 28 have been produced in a conventional manner from a preform of the printing forme, which preform has a fixed grid of openings. For illustration purposes, the bottom left-hand corner of FIG. 6 shows part of the preform in the form of screen 30 exposed by local removal of a photoresist layer 32 (indicated as black areas in the figure). Through-openings 34 are separated by dykes 36. The abovementioned conventional method comprises the application of the photoresist layer 32, which is exposed through a film (not shown), developed and stoved. This is carried out with a different preform for each colour. FIGS. 6-9 show the printing formes for each colour obtained in this way. As will be clear from these figures, not all the printing openings 40 are completely open. In other words, the shape, diameter, etc. of the printing openings 40 are not always identical to that of the round openings 34 in the preform 30, since the photoresist layer 32 partially covers the openings 34. This is the case in particular at the periphery (contours) of the printed images. In FIG. 6, a number of these printing openings which are not completely open are denoted by reference numeral 42, while fully open printing openings are denoted by reference numeral 44. Consequently, the dividing lines 2 will be printed incompletely, irregularly and in broken form on the substrate to be printed when the printing forme shown in FIG. 6 is used. The same phenomenon of incompletely open openings is also to be found in FIGS. 7-9. An improvement to the quality of the printed images can only be achieved by using a finer grid of openings (higher mesh number of, for example >200) in the preform, but this entails the drawbacks which have already been described above.

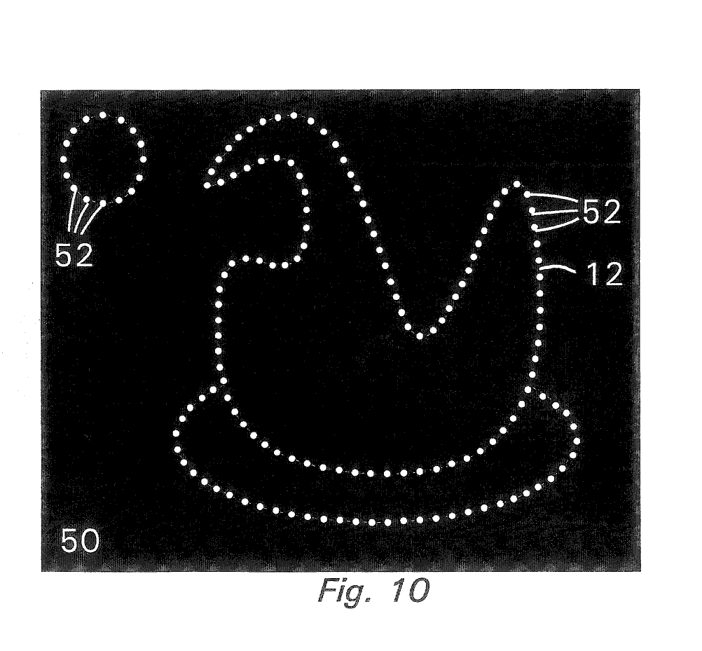

FIGS. 10-13 show printing formes which have been produced according to the invention, starting from a solid preform, which is either a hollow, thin-walled cylinder, for example made from plastic, or a flat, thin plate, in which contour printing openings and ordinary printing openings are formed using, for example, radiation from a movable laser device with the aid of a suitable algorithm, on or at a predetermined distance from the contour lines 12, 14, 16 and 18 from the corresponding FIGS. 2-5.

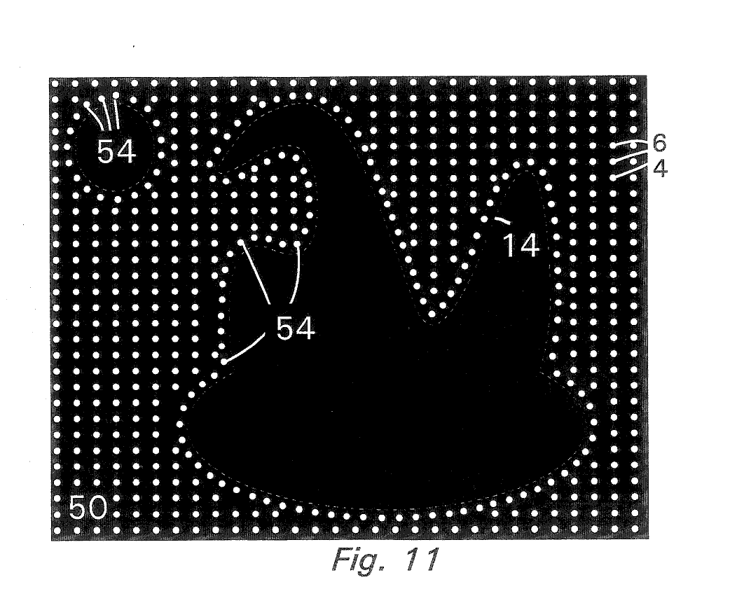

More particularly, in FIG. 10 contour printing openings 52 have been made in a preform 50 on the contour line 12 which defines the black dividing lines 2. In FIGS. 11-13, contour printing openings 54, 56 and 58, respectively, have been made at a predetermined, fixed distance (for example of 0.2 mm) from the corresponding contour lines 14, 16 and 18, in order to take into account the spreading of the printing ink used in the substrate.

It should be clear that the step size (positioning accuracy) of the laser device used must be much smaller than the distance between the contour printing openings which are to be made. In practice this should be by a factor of 10 or more. The diameter of the contour printing openings which are made using a CO₂ laser is at least 40 micrometers, and typically of the order of 100 micrometers.

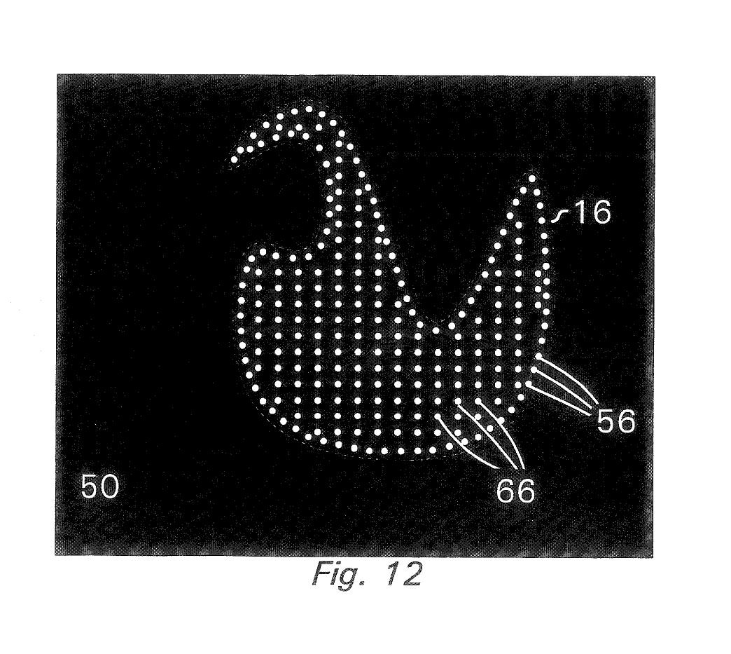

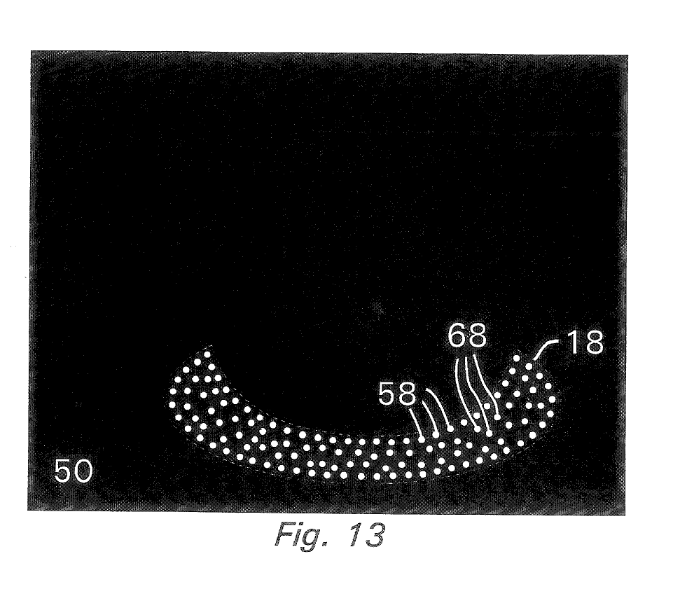

To obtain a fully covering solid print, in addition to the contour printing openings 54, 56 and 58 additional printing openings 64, 66 and 68, respectively, are also made inside the imaginary contour lines which are formed by the contour printing openings in question. These additional printing openings may be arranged in accordance with a regular grid (FIGS. 11 and 12) or an irregular grid (FIG. 13). Of course, mixed arrangements are also possible. All the printing openings, i.e. contour printing openings 52, 54, 56 and 58 and additional printing openings 64, 66, 68 are fully open, so that these printing formes can be used to print a much sharper image corresponding to the original shown in FIG. 1 without the need for a finer grid of openings in the preform.

What is claimed is

1. Method for producing a printing forme with printing openings which define an image which is to be printed, comprising the steps of determining the contours of the image to be printed and positioning and making contour printing openings in accordance with the determined contours, on the contour lines or at a predetermined, fixed distance therefrom, in a preform of the printing forme.

2. Method according to claim 1, wherein the contour printing openings are made at fixed distances from one another.

3. Method according to claim 1, wherein the contour printing openings are made by perforation of a preform of the printing forme with high-energy radiation.

4. Method according to claim 1, comprising the further step of positioning additional printing openings inside the area which is delimited by the contour printing openings.

5. Method according to claim 4, wherein the additional printing openings are made by perforation of a preform of the printing forme with high-energy radiation.

6. Method according to claim 1, wherein the printing forme with contour printing openings is produced by means of electroforming.

7. Printing method for printing a substrate with a printed image using a printing forme which is produced according to claim 1.
